(19) United States
(12) Patent Application Publication
(10) Pub. No.: US 2026/0279965 A1
(43) Pub. Date: Sep. 17, 2026

(54) BATTERY COOLING DEVICE, BATTERY HEAT DISSIPATION MECHANISM, AND UNMANNED AERIAL VEHICLE BATTERY CHARGING STATION

(71) Applicant: GUANGZHOU XAIRCRAFT TECHNOLOGY CO., LTD., Guangzhou (CN)

(72) Inventors: Zijia PENG, Guangzhou (CN); Dingfeng XIAO, Guangzhou (CN)

(73) Assignee: GUANGZHOU XAIRCRAFT TECHNOLOGY CO., LTD., Guangzhou (CN)

(21) Appl. No.: 19/669,895

(22) Filed: May 6, 2026

Related U.S. Application Data
(63) Continuation of application No. PCT/CN2024/101893, filed on Jun. 27, 2024.

(30) Foreign Application Priority Data
Nov. 8, 2023 (CN) 202311487136.5
Nov. 8, 2023 (CN) 202323020565.X

(51) Int. Cl. H01M 10/6569; B60L 53/16; B60L 53/30; H01M 10/613; H01M 10/625; H01M 50/249

(52) U.S. Cl. CPC H01M 10/6569; B60L 53/16; B60L 53/30; H01M 10/613; H01M 10/625; H01M 50/249; B60L 2200/10; H01M 2220/20

(57) ABSTRACT

A battery cooling device includes a liquid storage tank, an atomizer, a battery connecting assembly, and a fan. The liquid storage tank is provided with a liquid storage chamber and an atomization outlet in communication with the liquid storage chamber. The atomizer, disposed in the liquid storage chamber, is configured to atomize liquid in the liquid storage chamber into droplets, so that the droplets flow out through the atomization outlet. The battery connecting assembly is used to carry a battery. The fan is configured to blow the droplets to the battery connecting assembly to cool the battery. Since the droplets vaporize upon contacting the battery in the battery connecting assembly, water vapor is utilized to absorb heat through evaporation.

### CROSS-REFERENCE TO RELATED APPLICATIONS

This application is a continuation of International Application No. PCT/CN2024/101893, filed on Jun. 27, 2024, which claims priority to Chinese Patent Application No. 202311487136.5, filed on Nov. 8, 2023, and Chinese Patent Application No. 202323020565.X, filed on Nov. 8, 2023. All of the aforementioned patent applications are hereby incorporated by reference in their entireties.

### TECHNICAL FIELD

The present application relates to the field of battery heat dissipation technologies, and in particular, to a battery cooling device, a battery heat dissipation mechanism, and an unmanned aerial vehicle battery charging station.

### BACKGROUND

In related technologies, unmanned aerial vehicle (UAV) batteries utilize air cooling or water cooling methods to accelerate battery heat dissipation. Since air cooling is limited by ambient temperature, air cooling often fails to provide adequate cooling during hot summer months. The water cooling method typically involves immersing the battery in a pool of water. As most components of the battery are not water-resistant, only a portion of the battery is submerged, leaving the remaining part of the battery still unable to achieve effective heat dissipation. Therefore, the current heat dissipation effect for the unmanned aerial vehicle batteries remains unsatisfactory.

### SUMMARY

The present application provides a battery cooling device, a battery heat dissipation mechanism, and an unmanned aerial vehicle battery charging station, which can improve the heat dissipation effect on batteries.

In a first aspect, embodiments of the present application provides a battery cooling device, including: a liquid storage tank, the liquid storage tank being provided with a liquid storage chamber and an atomization outlet, the liquid storage chamber being in communication with the atomization outlet; an atomizer, the atomizer being disposed in the liquid storage chamber, the atomizer being configured to atomize liquid in the liquid storage chamber into droplets, so that the droplets flow out through the atomization outlet; a battery connecting assembly, the battery connecting assembly being connected to the liquid storage tank, the battery connecting assembly being configured to connect a battery; and a fan, the fan being provided on the liquid storage tank; where the fan is configured to blow the droplets to the battery connecting assembly to cool the battery.

According to the battery cooling device provided by the present application, the battery cooling device includes the liquid storage tank, the atomizer, the battery connecting assembly, and the fan. The liquid storage tank is provided with the liquid storage chamber and the atomization outlet, and the liquid storage chamber is in communication with the atomization outlet. The atomizer is disposed in the liquid storage chamber and is configured to atomize liquid in the liquid storage chamber into droplets to flow out from the atomization outlet. The battery connecting assembly is connected to the liquid storage tank and is configured to carry the battery. The fan is disposed on the liquid storage tank. The fan is configured to blow the droplets to the battery connecting assembly to cool the battery in the battery connecting assembly. Since the droplets vaporize upon contacting the battery in the battery connecting assembly, water vapor is utilized to absorb heat through evaporation. Combined with the fan blowing air, air cooling is used to carry away heat from the high-temperature battery, thereby improving the heat dissipation effect on the battery.

In a second aspect, an embodiment of the present application provides an unmanned aerial vehicle battery charging station, including a battery, a charging device, and the battery cooling device according to any of the foregoing implementations of the first aspect of the present application. When the battery is mounted on the battery connecting assembly of the battery cooling device, the charging device is electrically connected to the battery to charge the battery.

In a third aspect, an embodiment of the present application provides a battery heat dissipation mechanism, including: the battery cooling device according to any of the foregoing implementations of the first aspect of the present application; a battery, including a battery body and a battery housing, the battery housing covering an exterior of the battery body, the battery housing being provided with a heat dissipation hole and an air inlet hole, a gap being provided between the battery body and the battery housing to form an airflow channel; a plug, the plug being electrically connected to the battery body, both the plug and the heat dissipation hole being located on a side of the battery away from the battery cooling device, and the air inlet hole being provided on a side of the battery adjacent to the battery cooling device; where the battery cooling device is in communication with the battery housing, the battery cooling device is configured to generate water mist and airflow, and to utilize the airflow to blow the water mist toward the air inlet hole to dissipate heat from the battery body, and the water mist after heat dissipation is discharged through the heat dissipation hole.

According to the battery heat dissipation mechanism of the embodiment of the present application, the battery heat dissipation mechanism includes the battery cooling device, the battery, and the plug. The battery includes the battery body and the battery housing. The battery housing covers the exterior of the battery body. The battery housing is provided with a heat dissipation hole and an air inlet hole, and a gap is provided between the battery body and the battery housing to form the airflow channel. The plug is electrically connected to the battery body. Both the plug and the heat dissipation hole are located on the side of the battery away from the battery cooling device, and the air inlet hole is provided on the side of the battery adjacent to the battery cooling device. The battery cooling device is in communication with the battery housing. The battery cooling device is configured to generate water mist and airflow, and to utilize the airflow to blow the water mist toward the air inlet hole to dissipate heat from the battery body. The water mist after heat dissipation is discharged through the heat dissipation hole. When the battery heat dissipation mechanism is in use, the battery body is mounted in the battery housing. The plug is electrically connected to the battery body. When the plug is connected to an external power source, the battery body is charged. The battery cooling device is in communication with the battery housing. The battery cooling device is configured to generate water mist and airflow, and to utilize the airflow to blow the water mist to the air inlet hole of the battery housing, causing the water mist to enter an airflow channel inside the battery housing to dissipate heat from the battery body. The water mist after heat dissipation is discharged through the heat dissipation hole. The battery heat dissipation mechanism can utilize water mist to dissipate heat from the battery body, providing a better heat dissipation effect and improving heat dissipation efficiency.

### BRIEF DESCRIPTION OF THE DRAWINGS

To illustrate technical solutions of the embodiments of the present application more clearly, the following will briefly introduce accompanying drawings required for describing the embodiments. It should be understood that the following accompanying drawings only show some embodiments of the present application and therefore should not be considered as limiting the scope. For those skilled in the art, other related drawings can also be obtained based on these accompanying drawings without creative effort.

FIG. 1 is a schematic diagram of a battery inserted into a battery connecting assembly provided in an embodiment of the present application.

FIG. 2 is a schematic diagram of a battery cooling device provided in an embodiment of the present application.

FIG. 3 is an exploded view of a battery cooling device provided in an embodiment of the present application.

FIG. 4 is a cross-sectional view of a battery cooling device provided in an embodiment of the present application.

FIG. 5 is a rear view of a battery cooling device provided in an embodiment of the present application.

FIG. 6 is a schematic diagram of a second side plate and a second guide protrusion provided in an embodiment of the present application.

FIG. 7 is a first schematic diagram of a tank body provided in an embodiment of the present application.

FIG. 8 is a second schematic diagram of a tank body provided in an embodiment of the present application.

FIG. 9 is a schematic diagram of an unmanned aerial vehicle system provided in an embodiment of the present application.

FIG. 10 is a first perspective schematic structural diagram of a battery heat dissipation mechanism provided in an embodiment of the present application.

FIG. 11 is a second perspective schematic structural diagram of a battery heat dissipation mechanism provided in an embodiment of the present application.

FIG. 12 is a third perspective schematic structural diagram of a battery heat dissipation mechanism provided in an embodiment of the present application.

FIG. 13 is a fourth perspective schematic structural diagram of a battery heat dissipation mechanism provided in an embodiment of the present application.

FIG. 14 is a schematic diagram of an unmanned aerial vehicle battery charging station provided in an embodiment of the present application.

FIG. 15 is a schematic structural diagram of a battery heat dissipation mechanism provided in another embodiment of the present application.

### DETAILED DESCRIPTION OF THE EMBODIMENTS

To make the objectives, technical solutions, and advantages of the embodiments of the present application clearer, the following will clearly and completely describe the technical solutions in the embodiments of the present application with reference to the accompanying drawings in the embodiments of the present application. Obviously, the described embodiments are part of the embodiments of the present application, not all of them. Components of the embodiments of the present application described and shown in the accompanying drawings herein can generally be arranged and designed in various different configurations.

Therefore, the following detailed description of the embodiments of the present application provided in the accompanying drawings is not intended to limit the scope of the present application as claimed, but merely represents selected embodiments of the present application. Based on the embodiments of the present application, all other embodiments obtained by those skilled in the art without creative effort shall fall within the scope of protection of the present application.

It should be noted that similar reference numerals and letters indicate similar items in the following accompanying drawings. Therefore, once an item is defined in one accompanying drawing, it does not need to be further defined and explained in subsequent accompanying drawings.

In the description of the present application, it should be noted that if terms such as "upper", "lower", "inner", "outer", etc., indicating orientation or positional relationships are used, they are based on orientation or positional relationships shown in the accompanying drawings, or orientation or positional relationships in which the product of the present application is customarily placed during use. They are only for the convenience of describing the present application and simplifying the description, and do not indicate or imply that the device or element referred to must have a specific orientation, be constructed and operated in a specific orientation, and therefore cannot be construed as limiting the present application.

Furthermore, if terms such as "first", "second", etc., appear, they are only used for distinguishing description and cannot be understood as indicating or implying relative importance.

It should be noted that the features in the embodiments of the present application can be combined with each other without conflict.

When power battery cells are subjected to high-rate discharging or charging, they release a significant amount of heat. During high-rate discharge usage, the temperature of the cell can reach over seventy-five degrees Celsius.

However, the battery can only support charging at temperatures below sixty degrees Celsius. Since the cell temperature determines its chemical properties and also affects its charging performance, the cell cannot be charged under high-temperature conditions. It must wait until the cell temperature drops to a certain level before charging is permitted; otherwise, the battery's service life will be severely impacted.

In scenarios involving frequent high-rate charging and discharging, rapidly restoring the discharged cell to the temperature range that permits charging will significantly improve operational efficiency. Simultaneously, it protects the cell from influence of high temperatures, keeping it within the normal operating range and extending its service life.

In existing technologies, unmanned aerial vehicle (UAV) batteries utilize air cooling or water cooling methods to accelerate heat dissipation. Since air cooling is limited by ambient temperature, air cooling often fails to provide adequate cooling during hot summer months. The water cooling method typically involves immersing the battery in a pool of water. As most components of the battery are not water-resistant, only a portion of the battery is submerged, leaving the remaining part of the battery still unable to achieve effective heat dissipation. Therefore, the current heat dissipation effect for the unmanned aerial vehicle batteries remains unsatisfactory.

Specifically, a common current battery water-cooling solution involves immersing the cell in water. Since the power batteries included in the unmanned aerial vehicle battery charging station require consideration of lightweight design, the batteries often utilize immersion for heat dissipation. However, since components such as the charging plug and the mainboard cannot come into contact with water, a water level for immersion generally must not exceed two-thirds of a height of the cell. This results in the inability to dissipate heat from areas like tabs and vicinity of the mainboard through the immersion method. The high temperatures at the tab and mainboard can adversely affect the battery's charging and discharging performance as well as charging efficiency.

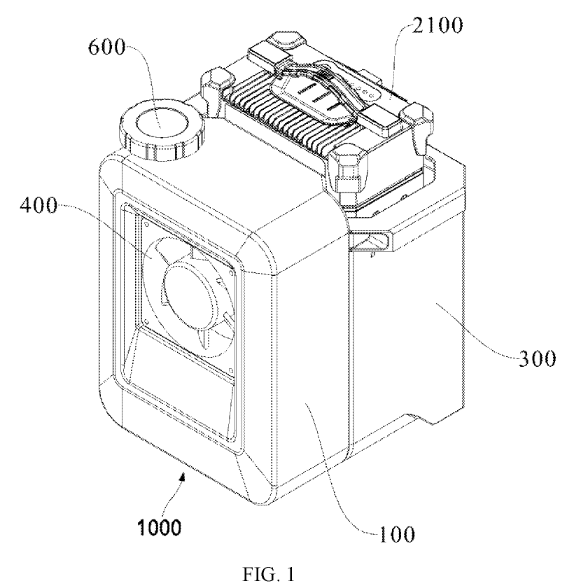

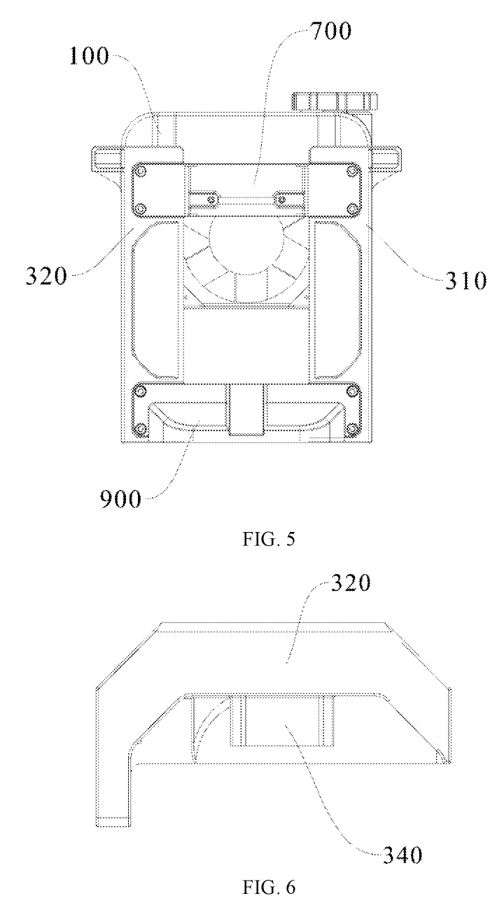

In view of above, referring to FIGS. 1-9, a battery cooling device 1000 and an unmanned aerial vehicle battery charging station 4200 provided in the embodiments of the present application can solve this problem, which will be described in detail below.

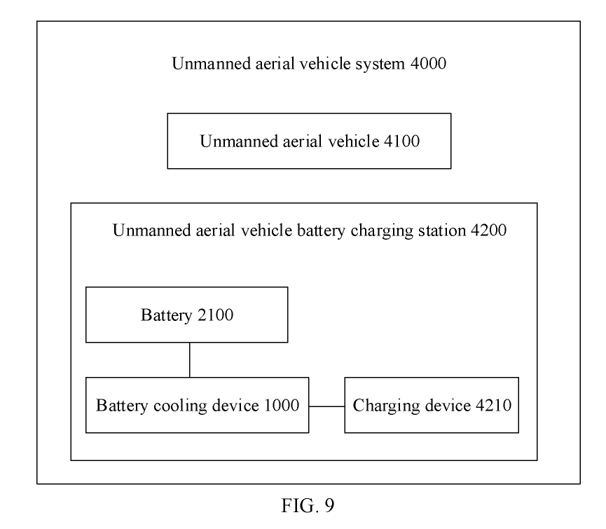

Referring to FIG. 9, an embodiment of the present application provides an unmanned aerial vehicle system 4000. The unmanned aerial vehicle system 4000 includes an unmanned aerial vehicle 4100 and an unmanned aerial vehicle battery charging station 4200. A battery 2100 in the unmanned aerial vehicle battery charging station is configured to be mounted on the unmanned aerial vehicle.

Herein, the unmanned aerial vehicle 4100 is a rotary-wing unmanned aerial vehicle (UAV), specifically a quadcopter. It could also be a single-rotor UAV, a dual-rotor UAV, a hexacopter, an octocopter, or other types. The UAV 4100 can operate automatically according to preset parameters such as path, flight speed, attitude, or be manually controlled by an operator.

Referring to FIGS. 1-3, the unmanned aerial vehicle battery charging station 4200 includes a battery 2100, a charging device 4210, and a battery cooling device 1000. The battery 2100 can be understood as a power battery 2100, which is configured to be mounted on the unmanned aerial vehicle 4100 to provide power.

When the battery 2100 is placed in the battery connecting assembly 300 of the battery cooling device 1000, the charging device 4210 is electrically connected to the battery 2100 to charge the battery 2100. Specifically, when the unmanned aerial vehicle needs charging, the battery 2100 can be placed into the battery cooling device 1000 to rapidly dissipate heat, lowering its temperature to a level suitable for charging. The charging device 4210 can then charge the battery 2100, thereby reducing the waiting time for the battery 2100 to cool down and improving operational efficiency of the unmanned aerial vehicle.

Specifically, referring to FIGS. 1-4, the battery cooling device 1000 includes a liquid storage tank 100, an atomizer 200, a battery connecting assembly 300, and a fan 400. The liquid storage tank 100 is provided with a liquid storage chamber 103 and an atomization outlet 101. The liquid storage chamber 103 is in communication with the atomization outlet 101. The atomizer 200 is disposed in the liquid storage chamber 103 and is configured to atomize liquid in the liquid storage chamber 103 into droplets, so that the droplets flow out through the atomization outlet 101. The battery connecting assembly 300 is connected to the liquid storage tank 100 and is configured to carry the battery 2100. The fan 400 is provided on the liquid storage tank 100.

When the fan 400 blows air, the fan 400 is configured to direct the droplets toward the battery connecting assembly 300 to cool the battery 2100 in the battery connecting assembly 300. Since the droplets vaporize upon contacting the battery 2100 in the battery connecting assembly 300, water vapor is utilized to absorb heat through evaporation. Combined with the fan 400 blowing air, air cooling is used to carry away heat from the high-temperature battery 2100, thereby improving the heat dissipation effect on the battery 2100.

In this embodiment, the liquid storage tank 100 has an annular cavity structure. The liquid storage tank 100 surrounds a mist channel 102. The mist channel 102 is in communication with the atomization outlet 101. The fan 400 is provided in the mist channel 102. The atomization outlet 101 is arranged on the upper side of the mist channel 102. Herein, the upper side of the mist channel 102 can be understood as a top side of the mist channel 102 during a working state of the battery cooling device 1000.

That is, the atomization outlet 101 is formed on the top wall of the mist channel 102, and a height of the atomization outlet 101 is greater than or equal to a highest point of the fan 400. The higher the position of the atomization outlet 101 is, the greater the liquid storage capacity of the liquid storage tank 100 can be.

The fan 400 is used to blow the droplets in the mist channel 102 to the battery connecting assembly 300.

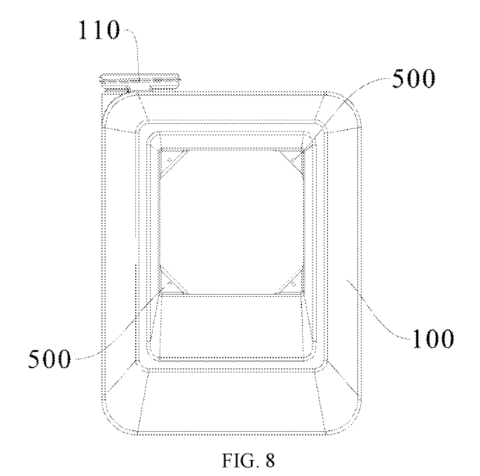

Specifically, the liquid storage tank 100 is a rectangular ring structure (as shown in FIG. 8), and the cross-section of the mist channel 102 along an airflow direction is rectangular to facilitate adaptation to a shape of the fan 400.

It should be understood that the annular cavity structure of the liquid storage tank 100 facilitates the mounting of the fan 400. The tank body can be made of metal or non-metal. Meanwhile, it facilitates the formation of the mist channel 102. The droplets exiting from the atomization outlet 101 enter the mist channel 102, mix with the airflow brought by the fan 400 to form an atomized airflow, which is then brought into the battery connecting assembly 300 to rapidly dissipate heat from the battery 2100.

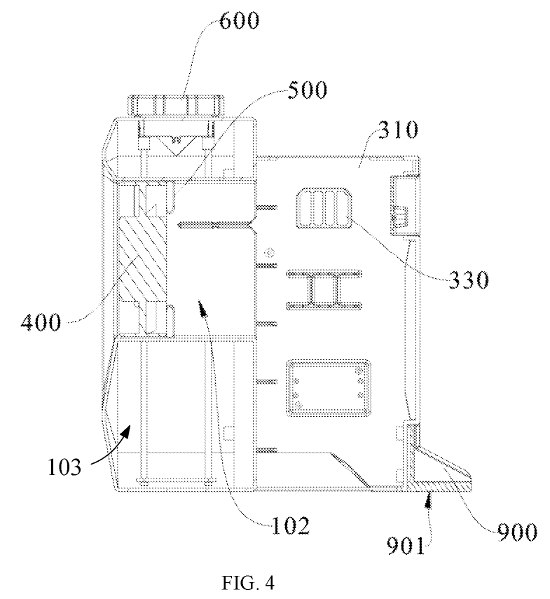

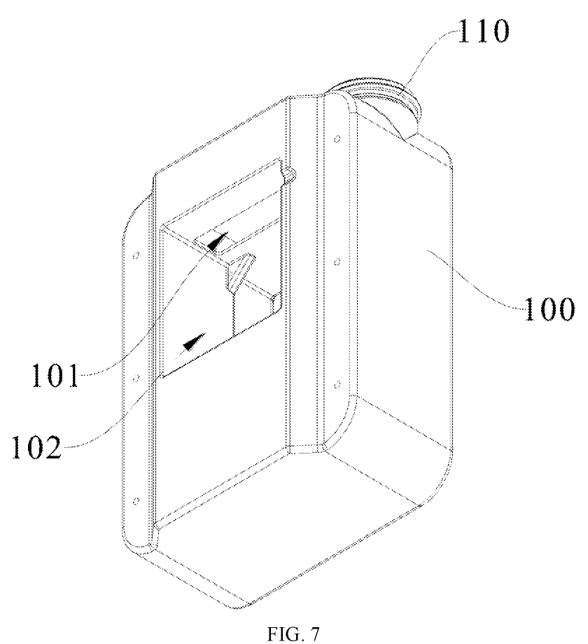

Referring to FIGS. 7 and 8 in conjunction with FIG. 4, the fan 400 is detachably mounted in the mist channel 102. For example, the liquid storage tank 100 is provided with four fan mounting plates 500, which are integrally formed with the liquid storage tank 100. All four fan mounting plates 500 are located within the mist channel 102, and the fan 400 is detachably mounted on these four fan mounting plates 500.

For example, as a detachable mounting method, the fan 400 can be secured to the four fan mounting plates 500 via fasteners (for example, screws). When disassembly is needed, the fasteners are removed to separate the fan 400 from the liquid storage tank 100, facilitating transportation.

Furthermore, in this embodiment, the battery connecting assembly 300 is detachably mounted on the liquid storage tank 100. The battery connecting assembly 300 includes a first side plate 310 and a second side plate 320 spaced apart from each other. Both the first side plate 310 and the second side plate 320 are detachably mounted on the liquid storage tank 100 and are configured to jointly carry the battery 2100.

The first side plate 310 and the second side plate 320 may be made of metal or non-metal.

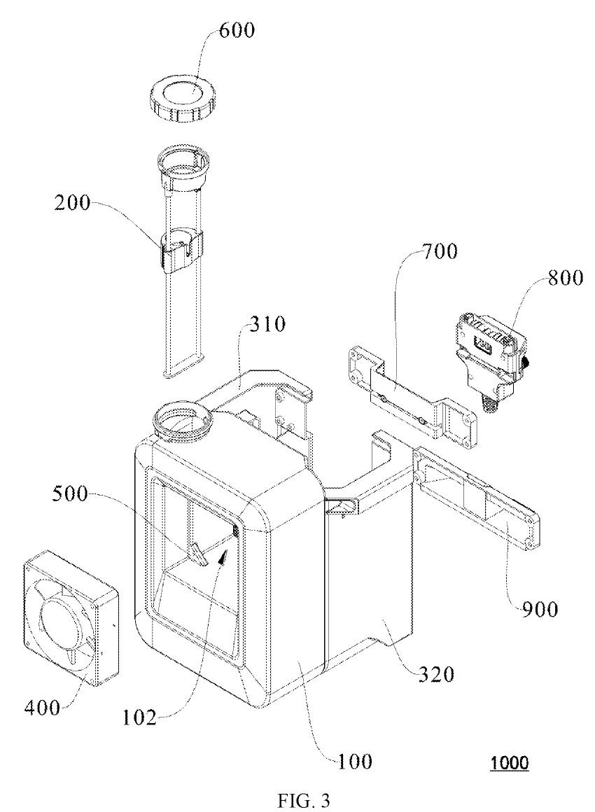

Referring to FIGS. 3 and 4 in conjunction with FIG. 6 again, the first side plate 310 and the second side plate 320 define a mounting space for the battery 2100. Part of the structure of the battery 2100 is located within the mounting space for the battery 2100. That is to say, the droplets exiting from the atomization outlet 101 enter the mist channel 102, mix with the airflow brought by the fan 400 to form the atomized airflow, which is then brought into the mounting space for the battery 2100 to rapidly dissipate heat from the battery 2100.

For example, as a detachable mounting method for the first side plate 310 and the second side plate 320, the first side plate 310 and the second side plate 320 are connected to a back side of the liquid storage tank 100 via fasteners (for example, screws), while the fan 400 is positioned near a front side of the liquid storage tank 100. When disassembly is needed, the fasteners are removed to separate the first side plate 310 from the liquid storage tank 100 and the second side plate 320 from the liquid storage tank 100, facilitating transportation.

It should be noted that, to facilitate the insertion of the battery 2100 into the mounting space for the battery 2100 and to limit the battery 2100 at a certain height, the battery connecting assembly 300 further includes a first guide protrusion 330 and a second guide protrusion 340. The first guide protrusion 330 and the second guide protrusion 340 are respectively provided on the first side plate 310 and the second side plate 320.

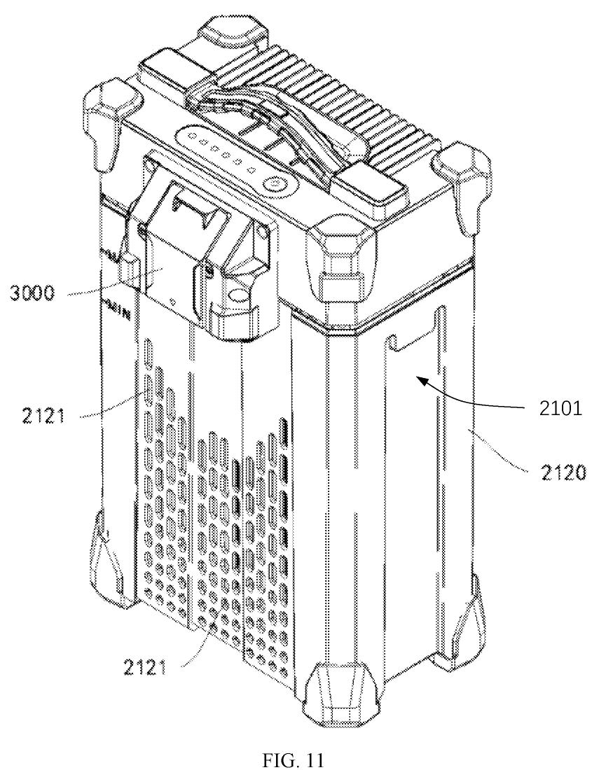

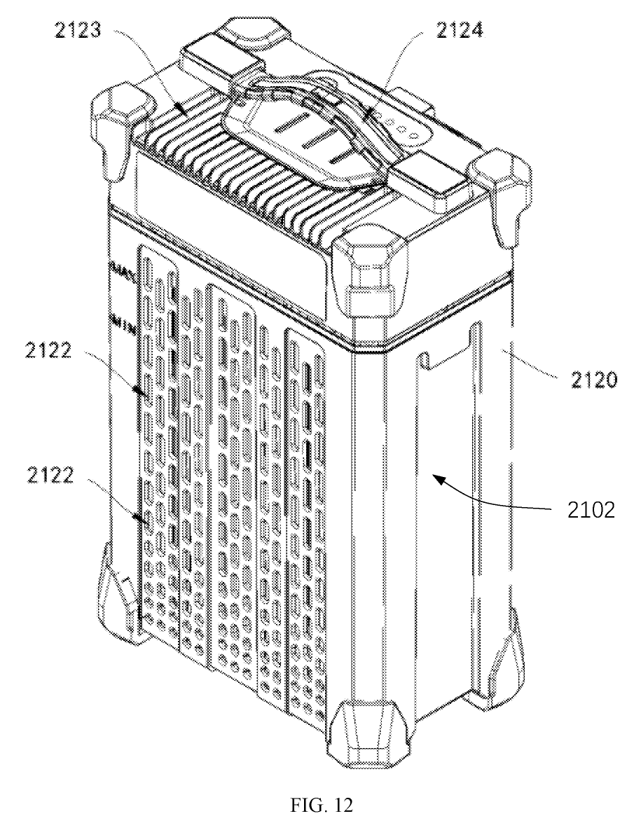

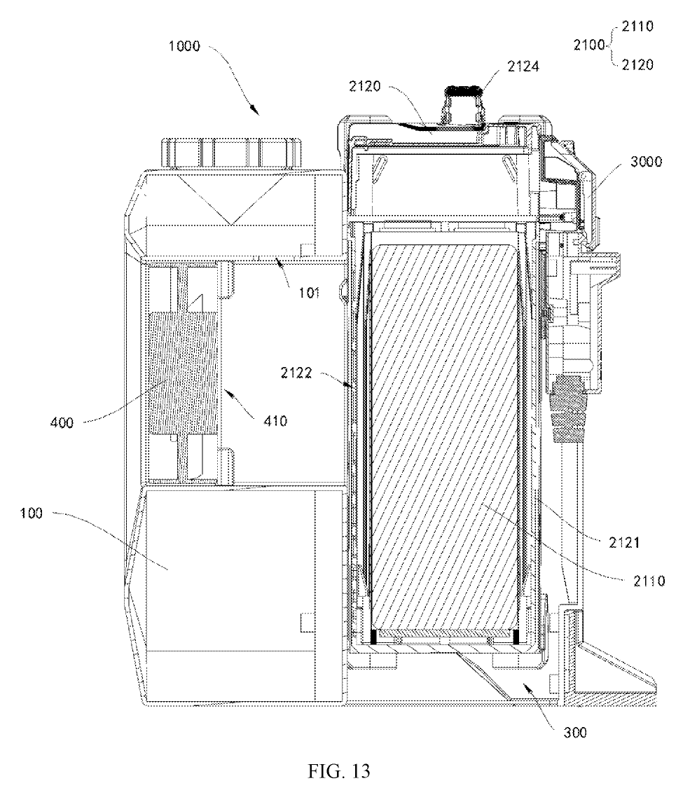

Referring to FIGS. 11 and 12, the battery 2100 is provided with a first guide groove 2101 and a second guide groove 2102. The first guide protrusion 330 is configured to be slidably disposed in the first guide groove 2101 of the battery 2100 and abut against the battery 2100. The second guide protrusion 340 is configured to be slidably disposed in the second guide groove 2102 of the battery 2100 and abut against the battery 2100.

It should be understood that a length of the first guide groove 2101 along its extension direction and a length of the second guide groove 2102 along its extension direction determine a height at which the battery 2100 is mounted in the mounting space for the battery 2100. That is, when the battery 2100 is inserted into the mounting space for the battery 2100 and properly mounted, the first guide protrusion 330 and the second guide protrusion 340 will respectively abut against an end sidewall of the first guide groove 2101 and an end sidewall of the second guide groove 2102, limiting the battery 2100 at a certain height.

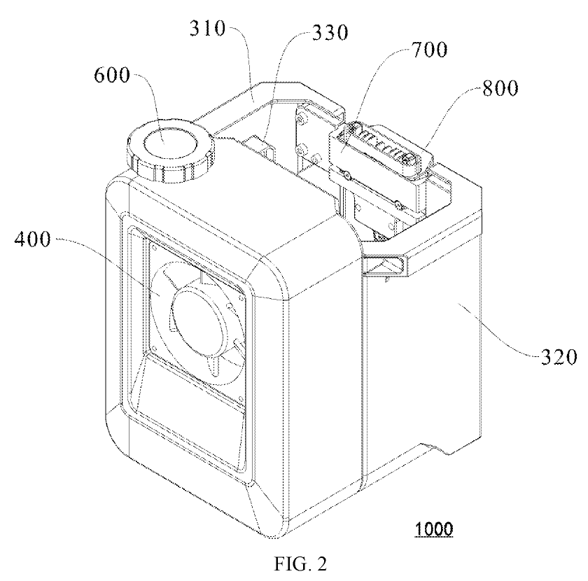

Referring to FIGS. 2 and 3 again, furthermore, the battery cooling device 1000 further includes a charging plug holder 700 and a charging plug 800. Since the charging plug 800 needs to be electrified, the charging plug holder 700 and a housing of the charging plug 800 are made of non-metallic materials.

The charging plug holder 700 is detachably mounted on the battery connecting assembly 300. Specifically, the charging plug holder 700 is simultaneously detachably connected to the first side plate 310 and the second side plate 320. The detachable mounting method for the charging plug 800 fixing component can refer to the mounting method of the fan 400 and the fan mounting plates 500 mentioned above, and will not be repeated here.

The charging plug 800 may also be detachably mounted on the charging plug holder 700. The charging plug 800 is simultaneously electrically connected to the fan 400 and the atomizer 200. The charging plug 800 can supply power from the charging device 4210 via wires to the atomizer 200 and the fan 400.

It should be noted that when the battery 2100 is inserted into the mounting space for the battery 2100 and properly mounted, the plug on the battery 2100 will be automatically connected to the charging plug 800 inserted in the plug holder, simplifying the battery 2100 connection operation.

Furthermore, it should be noted that in this embodiment, to facilitate liquid filling, the liquid storage tank 100 is provided with a liquid filling port 110, which is in communication with the liquid storage chamber 103. Meanwhile, the battery cooling device 1000 further includes a tank cover 600, which is mounted on the liquid filling port 110.For example, the tank cover 600 and the liquid filling port 110 are in threaded connection with each other.

Moreover, part of the structure of the atomizer 200 (such as a cylindrical structure at an upper end of the atomizer 200 in FIG. 3) will fit at the position of the liquid filling port 110 to facilitate the mounting of the atomizer 200.

In this embodiment, referring to FIGS. 3 and 4, the battery cooling device 1000 may further include a support foot pedal 900. The support foot pedal 900 may be made of metal or non-metal. The support foot pedal 900 is detachably mounted on the battery connecting assembly 300, that is, simultaneously detachably connected to the first side plate 310 and the second side plate 320. The detachable mounting method for the support foot pedal 900 can refer to the mounting method of the fan 400 and the fan mounting plates 500 mentioned above, and will not be repeated here.

The cross-section of the support foot pedal 900 is similar to a triangle (as shown in FIG. 4). The support foot pedal 900 can provide support for the entire battery cooling device 1000. Meanwhile, since the battery cooling device is relatively light, to prevent it from being lifted when pulling out the battery 2100, an operator can step on the support foot pedal 900 to perform the battery 2100 removal operation.

For example, the support foot pedal 900 is located on a side of the battery connecting assembly 300 away from the liquid storage tank 100, and a height of the charging plug holder 700 is greater than a height of the support foot pedal 900.

The support foot pedal 900 is provided with a supporting surface 901. The supporting surface 901 is flush with a bottom wall of the battery connecting assembly 300 to better ensure the stability of the entire battery cooling device 1000.

According to the battery cooling device 1000 provided in this embodiment, the working principle of the battery cooling device 1000 is as follows.

When heat dissipation is needed for the battery 2100, the battery 2100 may be placed into the battery connecting assembly 300. The battery 2100 is electrically connected to the charging plug 800. Simultaneously the fan 400 and the atomizer 200 are started. The atomizer 200 begins to generate atomized droplets. The droplets exiting from the atomization outlet 101 enter the mist channel 102, mix with the airflow brought by the fan 400 to form an atomized airflow, which is then brought into the mounting space for the battery 2100. Through the evaporation of the droplets on the surface of the battery 2100, the temperature on the surface of the battery 2100 is reduced, rapidly completing the cooling for the battery 2100.

Afterwards, the charging device 4210 can charge the battery 2100, reducing the waiting time for the battery 2100 to cool and improving operational efficiency of the unmanned aerial vehicle.

In view of above, the battery cooling device 1000 includes the liquid storage tank 100, the atomizer 200, the battery connecting assembly 300, and the fan 400. The liquid storage tank 100 is provided with the liquid storage chamber 103 and the atomization outlet 101, and the liquid storage chamber 103 is in communication with the atomization outlet 101. The atomizer 200 is disposed in the liquid storage chamber 103 and is configured to atomize liquid in the liquid storage chamber 103 into droplets to flow out from the atomization outlet 101. The battery connecting assembly 300 is connected to the liquid storage tank 100 and is configured to carry the battery 2100. The fan 400 is disposed on the liquid storage tank 100. The fan 400 is configured to blow the droplets to the battery connecting assembly 300 to cool the battery 2100 in the battery connecting assembly 300. Since the droplets vaporize upon contacting the battery 2100 in the battery connecting assembly 300, water vapor is utilized to absorb heat through evaporation. Combined with the fan 400 blowing air, air cooling is used to carry away heat from the high-temperature battery 2100, thereby improving the heat dissipation effect on the battery 2100.

The unmanned aerial vehicle battery charging station includes the battery 2100, a charging device 4210, and the aforementioned battery cooling device 1000. When the battery 2100 is mounted in the battery connecting assembly 300 of the battery cooling device 1000, the charging device 4210 is electrically connected to the battery 2100 to charge it. The unmanned aerial vehicle battery charging station possesses all the functions of the aforementioned battery cooling device 1000.

The unmanned aerial vehicle system 4000 includes an unmanned aerial vehicle 4100 and the aforementioned unmanned aerial vehicle battery charging station 4200. The battery 2100 is configured to be mounted on the unmanned aerial vehicle 4100. The unmanned aerial vehicle system 4000 possesses all the functions of the aforementioned unmanned aerial vehicle battery charging station 4200.

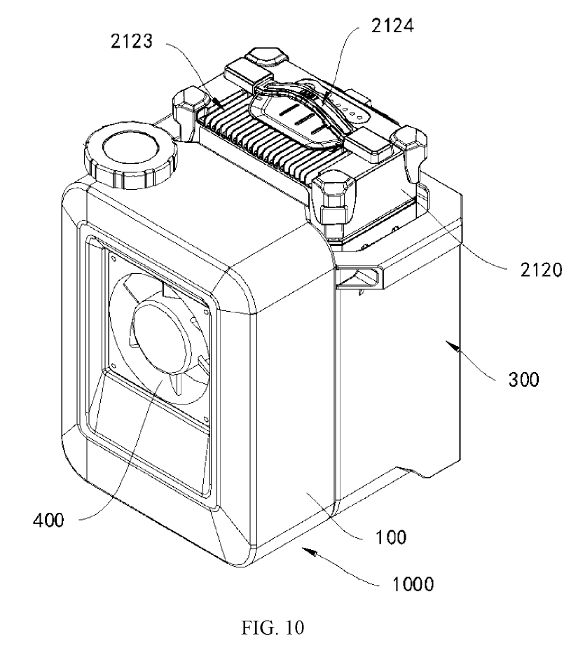

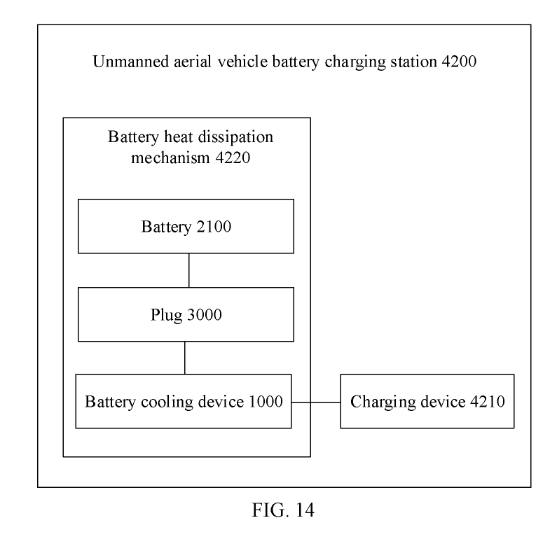

Referring to FIGS. 10-14, this embodiment provides an unmanned aerial vehicle battery charging station 4200. The unmanned aerial vehicle battery charging station 4200 includes a charging device 4210 and a battery heat dissipation mechanism 4220. The charging device 4210 is used to charge the battery. The battery cooling device 1000 is used to dissipate heat from the battery during charging.

Referring to FIGS. 10-13, the battery heat dissipation mechanism 4220 includes a battery 2100, a plug 3000, and a battery cooling device 1000. The battery cooling device 1000 can be the battery cooling device 1000 from any of the preceding embodiments. The battery includes a battery body 2110 and a battery housing 2120. The battery housing 2120 covers an exterior of the battery body 2110. The battery housing 2120 is provided with a heat dissipation hole 2121 and an air inlet hole 2122. A gap is provided between the battery body 2110 and the battery housing 2120 to form an airflow channel. The plug 3000 is arranged on the battery housing 2120 and is electrically connected to the battery body 2110. Both the plug 3000 and the heat dissipation hole 2121 are located on a side of the battery away from the battery cooling device 1000. The air inlet hole 2122 is provided on a side of the battery adjacent to the battery cooling device 1000. The plug 3000 and the heat dissipation hole 2121 are on the same side and spaced apart. The battery cooling device 1000 is in communication with the battery housing 2120. The battery cooling device 1000 is configured to generate water mist and airflow, and to utilize the airflow to blow the water mist toward the air inlet hole 2122 to dissipate heat from the battery body 2110. The water mist after heat dissipation is discharged through the heat dissipation hole 2121.

Specifically, in existing technologies, batteries generate heat during operation, and excessively high temperatures can affect the battery’s own performance. Therefore, it is necessary to equip the battery with a heat dissipation structure. The air-cooling or water-cooling methods used in existing technologies both suffer from inadequate heat dissipation effectiveness. Furthermore, the water-cooling method can cause short circuits at the battery's plug. To solve these technical problems, when using the battery heat dissipation mechanism 4220 provided in this embodiment, the battery body 2110 is mounted in the battery housing 2120. The plug 3000 is electrically connected to the battery body 2110, and the plug 3000 is connected to an external power source to charge the battery body 2110. The battery cooling device 1000 is in communication with the battery housing 2120 and is configured to generate a water mist and an airflow, using the airflow to blow the water mist toward the air inlet hole 2122 of the battery housing 2120, so that the water mist enters the airflow channel inside the battery housing 2120 to dissipate heat from the battery body 2110. The water mist after heat dissipation is discharged through the heat dissipation holes 2121. This battery heat dissipation mechanism 4220 can utilize water mist to dissipate heat from the battery body 2110, providing better heat dissipation effect and improving heat dissipation efficiency.

In this embodiment, the battery housing 2120 has a rectangular structure. The heat dissipation hole 2121 and the air inlet hole 2122 are arranged on opposite sides of the battery housing 2120. The plug 3000 is disposed above the heat dissipation hole 2121 and spaced apart from the heat dissipation hole 2121. The plug 3000 and the heat dissipation holes 2121 are spaced apart, ensuring that the water mist inside the battery housing 2120 is concentrated and discharged away from the plug 3000, thereby preventing water mist from accumulating around the plug 3000, protecting the plug 3000 from water mist erosion and avoiding short-circuit phenomena.

Specifically, the heat dissipation hole 2121 is a strip-shaped hole and/or a circular hole. In this embodiment, heat dissipation holes 2121 include strip-shaped holes and/or circular holes. In other embodiments, the heat dissipation holes 2121 may only include strip-shaped holes, or only include circular holes, which is not specifically limited here.

It should be noted that heat dissipation holes 2121 closer to the plug 3000 may be the strip-shaped holes, while those farther from the plug 3000 may be the circular holes. An upper portion of the battery body 2110 generates more heat during discharge than a lower portion of the battery body 2110. Therefore, after dissipating heat from the battery body 2110, the water mist carrying away the heat will flow toward the heat dissipation holes 2121 for discharge. Since the heat dissipation holes 2121 are mainly concentrated in the middle and lower portions of the battery housing 2120, the water mist carrying away the heat from the battery body 2110 will first reach the strip-shaped holes and then the circular holes during its flow. As a heat dissipation area of the strip-shaped holes is larger than that of the circular holes, the water mist carrying away the heat from the battery body 2110 can be quickly discharged through the strip-shaped holes, improving heat dissipation efficiency.

Since the upper portion of the battery body 2110 generates more heat during discharge than the lower portion, in this embodiment, the battery cooling device 1000 is arranged at the upper portion of the battery body 2110. The water mist generated by the battery cooling device 1000 is directed at the upper portion of the battery body 2110 for concentrated heat dissipation, which can improve heat dissipation efficiency and speed up the cooling process.

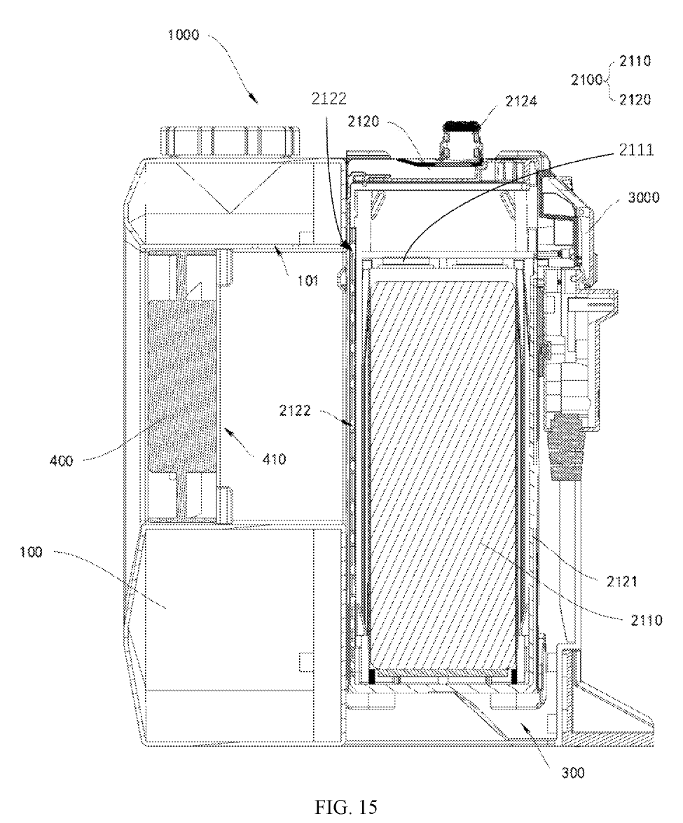

Specifically, referring to FIG. 15, the battery body 2110 is provided with a tab 2111. A height of a highest point of the air inlet hole 2122 is greater than or equal to a height of the tab 2111 of the battery body 2110. Generally, a plurality of battery bodies are connected via the tab 2111. During battery charging, the tab 2111 may have the highest temperature. Concentrating the air inlet hole 2122 near the location of the tab 2111 for heat dissipation can shorten the battery's cooling time, speed up the cooling of the battery, and ensure temperature distribution uniformity of the battery. In this embodiment, the height of the highest point of the air inlet hole 2122 is equal to the height of the tab 2111 of the battery body 2110. In other embodiments, the height of the highest point of the air inlet hole 2122 may be greater than the height of the tab 2111 of the battery body 2110.

It should also be noted that the battery cooling device 1000 includes an atomizer, a liquid storage tank 100, and a fan 400. The liquid storage tank 100 is connected to the atomizer. The atomization outlet 101 is disposed between an air outlet 410 of the fan 400 and the battery housing 2120. The fan 400 is configured to blow air toward the air inlet hole 2122. The atomizer is configured to atomize liquid in the liquid storage tank 100. The water mist generated flows out from the atomization outlet 101, mixes with air blown by the fan 400, and are together blown toward the air inlet hole 2122 to enter the airflow channel of the battery housing 2120 to dissipate heat from the battery body 2110. In this embodiment, the liquid storage tank 100 is a water tank.

In this embodiment, a position of the air outlet 410 of the fan 400 corresponds to a position of the upper portion of the battery body 2110, enabling targeted heat dissipation aimed at the upper portion of the battery body 2110. The airflow driven by the fan 400, combined with the water mist flowing out from the atomizer, is directly and concentratedly blown toward the tab position at the upper portion of the battery body 2110, carrying away the heat at the tab position. Thus, the heat dissipation may be more precise, allowing for targeted cooling work, ensuring the temperature distribution uniformity of the battery body 2110, improving the battery's service life, and simultaneously enhancing the battery's heat dissipation effect.

During operation, the fan 400 blows air toward the upper portion of the battery body 2110. The atomizer atomizes the liquid inside the liquid storage tank 100. The water mist generated flows out from the atomization outlet 101 to combine with the air blown out from the air outlet 410 of the fan 400, and together they are blown toward the upper portion of the battery body 2110. This can directly carry away the heat from the tab position of the battery body 2110. The water mist that has carried away the heat then moves toward the lower portion of the battery body 2110 and is finally discharged through the heat dissipation hole 2121.

In this embodiment, to ensure that the water mist can cover the tab position of the battery body 2110 as concentratedly as possible, a height of the atomization outlet 101 is greater than four-fifths of a height of the battery body 2110.

Furthermore, an aperture of an air inlet hole 2122 corresponding to the position of the upper portion of the battery body 2110 is greater than an aperture of an air inlet hole 2122 corresponding to the position of the lower portion of the battery body 2110. This allows the water mist generated by the battery cooling device 1000 to be more concentratedly aimed at the upper portion of the battery body 2110 for heat dissipation. Thus, the heat dissipation may be more precise, allowing for targeted cooling work, ensuring the temperature distribution uniformity of the battery body 2110, improving the battery's service life, and simultaneously enhancing the battery's heat dissipation effect.

For example, a quantity of the air inlet hole 2122 is greater than one, and a shape of an air inlet area formed collectively by the air inlet holes 2122 matches a shape of the battery body 2110.

To accelerate the heat dissipation efficiency of the battery body 2110, the top of the battery housing 2120 is provided with a heat sink 2123. The heat sink 2123 and the battery cooling device 1000 jointly dissipate heat from the battery body 2110. Simultaneously, the heat sink 2123 is disposed on the top of the battery housing 2120, enabling more targeted heat dissipation for the upper portion of the battery body 2110 and ensuring the temperature distribution uniformity of the battery.

To facilitate carrying and handling the battery, the battery heat dissipation mechanism 4220 may further include a handle 2124, which is connected to the battery housing 2120. Specifically, the handle 2124 is disposed on the top of the battery housing 2120.

In addition, the battery heat dissipation mechanism 4220 further includes a battery connecting assembly 300. The battery cooling device 1000 is detachably connected to the battery connecting assembly 300, and the battery housing 2120 is mounted on the battery connecting assembly 300.

In view of above, the embodiments of the present application provide the battery heat dissipation mechanism 4220 and the unmanned aerial vehicle battery charging station 4200. The battery heat dissipation mechanism 4220 includes the battery, the plug 3000, and the battery cooling device 1000. The battery includes the battery body 2110 and the battery housing 2120. The battery housing 2120 covers the exterior of the battery body 2110. The battery housing 2120 is provided with a heat dissipation hole 2121 and an air inlet hole 2122. The gap is provided between the battery body 2110 and the battery housing 2120 to form the airflow channel. The plug 3000 is provided on the battery housing 2120 and is electrically connected to the battery body 2110. The plug 3000 and the heat dissipation hole 2121 are both located on the side of the battery away from the battery cooling device 1000. The air inlet hole 2122 is arranged on the side of the battery adjacent to the battery cooling device 1000. The plug 3000 and the heat dissipation hole 2121 are located on the same side and are spaced apart. The battery cooling device 1000 is in communication with the battery housing 2120. The battery cooling device 1000 is configured to generate water mist and airflow, and to utilize the airflow to blow the water mist toward the air inlet hole 2122 to dissipate heat from the battery body 2110. The water mist after heat dissipation is discharged through the heat dissipation hole 2121. When using this battery heat dissipation mechanism 4220, the battery body 2110 is mounted in the battery housing 2120. The plug 3000 is electrically connected to the battery body 2110. The plug 3000 is connected to an external power supply to charge the battery body 2110. The battery cooling device 1000 is in communication with the battery housing 2120. The battery cooling device 1000 is used to generate water mist and airflow, and to utilize the airflow to blow the water mist toward the air inlet hole 2122 of the battery housing 2120, allowing the water mist to enter the airflow channel inside the battery housing 2120 to dissipate heat from the battery body 2110. The water mist after heat dissipation is discharged through the heat dissipation hole 2121. This battery heat dissipation mechanism 4220 can utilize water mist to dissipate heat from the battery body 2110, achieving better heat dissipation effects and improving heat dissipation efficiency.

The unmanned aerial vehicle battery charging station 4200 includes the charging device 4210 and the battery heat dissipation mechanism 4220. The charging device 4210 is configured to charge the battery, and the battery cooling device 1000 is configured to dissipate heat from the battery during battery charging. When the battery heat dissipation mechanism 4220 is in use, the battery body 2100 is mounted in the battery housing 2120. The plug 3000 is electrically connected to the battery body 2110. When the plug 3000 is connected to an external power source, the battery body 2110 is charged. The battery cooling device 1000 is in communication with the battery housing 2120. The battery cooling device 1000 is configured to generate water mist and airflow, and to utilize the airflow to blow the water mist to the air inlet hole 2122 of the battery housing 2120, causing the water mist to enter the airflow channel inside the battery housing 2120 to dissipate heat from the battery body 2110. The water mist after heat dissipation is discharged through the heat dissipation hole 2121. The battery heat dissipation mechanism 4220 can utilize water mist to dissipate heat from the battery body 2110, providing a better heat dissipation effect and improving heat dissipation efficiency.

The above descriptions are only specific implementations of the present application. However, the protection scope of the present application is not limited thereto. Any skilled in the art can easily conceive of changes or substitutions within the technical scope disclosed in the present application, which should be covered within the protection scope of the present application. Therefore, the protection scope of the present application should be subject to the protection scope of the claims.

What is claimed is:

1. A battery cooling device, comprising:
a liquid storage tank, the liquid storage tank being provided with a liquid storage chamber and an atomization outlet, the liquid storage chamber being in communication with the atomization outlet;
an atomizer, the atomizer being disposed in the liquid storage chamber, the atomizer being configured to atomize liquid in the liquid storage chamber into droplets, so that the droplets flow out through the atomization outlet;
a battery connecting assembly, the battery connecting assembly being connected to the liquid storage tank, the battery connecting assembly being configured to connect a battery; and
a fan, the fan being provided on the liquid storage tank;
wherein the fan is configured to blow the droplets to the battery connecting assembly to cool the battery.

2. The battery cooling device according to claim 1, wherein the liquid storage tank is an annular cavity structure, the liquid storage tank defines a mist channel, and the mist channel is in communication with the atomization outlet; and
the fan is configured to blow the droplets in the mist channel to the battery connecting assembly.

3. The battery cooling device according to claim 2, wherein the fan is detachably mounted in the mist channel.

4. The battery cooling device according to claim 3, wherein the liquid storage tank is provided with a fan mounting plate, the fan mounting plate is located within the mist channel, and the fan is detachably mounted on the fan mounting plate.

5. The battery cooling device according to claim 2, wherein the atomization outlet is formed in a top wall of the mist channel.

6. The battery cooling device according to claim 1, wherein the liquid storage tank is provided with a liquid filling port, and the liquid filling port is in communication with the liquid storage chamber; and
the battery cooling device further comprises a tank cover, wherein the tank cover is mounted on the liquid filling port.

7. The battery cooling device according to claim 1, wherein a height of the atomization outlet is greater than or equal to a highest point of the fan.

8. The battery cooling device according to claim 1, further comprising a charging plug holder, wherein the charging plug holder is mounted on the battery connecting assembly, and the charging plug holder is configured to mount a charging plug.

9. The battery cooling device according to claim 8, further comprising the charging plug, wherein the charging plug is mounted on the charging plug holder, and the charging plug is electrically connected to both the fan and the atomizer.

10. The battery cooling device according to claim 8, further comprising a support foot pedal, wherein the support foot pedal is mounted on the battery connecting assembly, wherein
the support foot pedal is provided on a side of the battery connecting assembly away from the liquid storage tank;
a height of the charging plug holder is greater than a height of the support foot pedal; and
the support foot pedal is provided with a supporting surface, and the supporting surface is flush with a bottom wall of the battery connecting assembly.

11. The battery cooling device according to claim 1, wherein the battery connecting assembly comprises a first side plate and a second side plate spaced apart from each other, both the first side plate and the second side plate are mounted on the liquid storage tank, and the first side plate and the second side plate are configured to jointly carry the battery.

12. The battery cooling device according to claim 11, wherein the battery connecting assembly further comprises a first guide protrusion and a second guide protrusion, and the first guide protrusion and the second guide protrusion are respectively provided on the first side plate and the second side plate;
wherein the first guide protrusion is configured to be slidably disposed in a first guide groove of the battery and abut against the battery, and the second guide protrusion is configured to be slidably disposed in a second guide groove of the battery and abut against the battery.

13. An unmanned aerial vehicle battery charging station, comprising a battery, a charging device, and the battery cooling device according to claim 1, wherein when the battery is mounted on the battery connecting assembly of the battery cooling device, the charging device is electrically connected to the battery to charge the battery.

14. The unmanned aerial vehicle battery charging station according to claim 13, wherein the battery is provided with a first guide groove and a second guide groove, the battery connecting assembly comprises a first side plate and a second side plate spaced apart from each other, both the first side plate and the second side plate are mounted on the liquid storage tank, and the first side plate and the second side plate are configured to jointly carry the battery;
the battery connecting assembly further comprises a first guide protrusion and a second guide protrusion, and the first guide protrusion and the second guide protrusion are respectively provided on the first side plate and the second side plate; and
the first guide protrusion is configured to be slidably disposed in the first guide groove of the battery and abut against the battery, and the second guide protrusion is configured to be slidably disposed in the second guide groove of the battery and abut against the battery.

15. A battery heat dissipation mechanism, comprising:
the battery cooling device according to claim 1;
a battery, comprising a battery body and a battery housing, the battery housing covering an exterior of the battery body, the battery housing being provided with a heat dissipation hole and an air inlet hole, a gap being provided between the battery body and the battery housing to form an airflow channel; and
a plug, the plug being electrically connected to the battery body, both the plug and the heat dissipation hole being located on a side of the battery away from the battery cooling device, and the air inlet hole being provided on a side of the battery adjacent to the battery cooling device;
wherein the battery cooling device is in communication with the battery housing, the battery cooling device is configured to generate water mist and airflow, and to utilize the airflow to blow the water mist toward the air inlet hole to dissipate heat from the battery body, and the water mist after heat dissipation is discharged through the heat dissipation hole.

16. The battery heat dissipation mechanism according to claim 15, wherein the battery housing is a rectangular structure, and the plug is disposed above the heat dissipation hole.

17. The battery heat dissipation mechanism according to claim 15, wherein the battery body is provided with a tab, and a height of a highest point of the air inlet hole is greater than or equal to a height of the tab of the battery body.

18. The battery heat dissipation mechanism according to claim 15, wherein an aperture of the air inlet hole corresponding to a position of an upper portion of the battery body is greater than an aperture of the air inlet hole corresponding to a position of a lower portion of the battery body.

19. The battery heat dissipation mechanism according to claim 15, wherein the battery cooling device comprises an atomizer, a liquid storage tank, and a fan, the liquid storage tank is connected to the atomizer, an atomization outlet is disposed between an air outlet of the fan and the battery housing, the fan is configured to blow air toward the air inlet hole, the atomizer is configured to atomize liquid in the liquid storage tank, and atomized liquid flows out from the atomization outlet, mixes with air blown by the fan, and together enters the battery housing through the air inlet hole to dissipate heat from the battery body.

20. The battery heat dissipation mechanism according to claim 19, wherein a height of the atomization outlet is greater than four-fifths of a height of the battery body.
